(19) United States
(12) Patent Application Publication
(10) Pub. No.: US 2019/0331961 A1
(43) Pub. Date: Oct. 31, 2019

(54) DISPLAY PANEL AND DISPLAY APPARATUS

(71) Applicants: HKC Corporation Limited, Shenzhen (CN); Chongqing HKC Optoelectronics Technology Co., Ltd., Chongqing (CN)

(72) Inventor: CHUNG-KUANG CHIEN, Chongqing (CN)

(21) Appl. No.: 16/462,240

(22) PCT Filed: Apr. 20, 2017
(86) PCT No.: PCT/CN2017/081231

§ 371 Date: May 19, 2019

(30) Foreign Application Priority Data
Mar. 14, 2017 (CN) 201710148720.6

(51) Int. Cl. G02F 1/1335

(52) U.S. Cl. CPC G02F 1/133528; G02F 1/1368; G02F 1/133514; G02F 1/133512

(57) ABSTRACT

This application provides a display panel and a display apparatus. The display panel includes a substrate, a backlight module disposed opposite to a back side of the substrate, and a polarized layer covering a lateral side of the substrate. The polarized layer includes a first polarized layer and a second polarized layer peripherally disposed on the first polarized; and a light transmittance of the second polarized layer is less than a light transmittance of the first polarized layer. Since the second polarized layer having lower light transmittance than the first polarized layer is disposed at a peripheral of the polarized layer, the influence of the peripheral metal dense line region is reduced, correspondingly a yield of the frameless production is increased.

This application claims priority to Chinese Patent Application No. CN2016112513322, filed with the Chinese Patent Office on Dec. 29, 2016 and entitled “DISPLAY PANEL AND DISPLAY APPARATUS”, which is incorporated herein by reference in its entirety.

### TECHNICAL FIELD

This application relates to the field of display screen, and more particularly to a display panel and a display apparatus.

### BACKGROUND

Statement herein merely provides background information related to this application and does not necessarily constitute the existing technology.

With development and improvement of technology, Liquid Crystal Display (LCD) apparatuses have more advantages, such as thin body, power saving, no radiation, and the LCD apparatuses are widely used. Most of the LCD apparatuses on the market are backlit type LCD apparatuses including a Liquid Crystal Display (LCD) panel and a backlight module. Operating principle of the LCD panel is that liquid crystal molecules are disposed between two substrates that are parallel to each other, and a driving voltage is applied to two substrates to control orientation of the liquid crystal molecules, further reflecting light of the backlight module and generating images.

As Thin Film Transistor Liquid Crystal Display (TFT-LCD) apparatuses have low power dissipation, good image quality, and high production yield and so on, the TFT-LCD apparatuses have gradually occupied a leading position in the display field. The TFT-LCD apparatuses include the LCD panel and the backlight module, where the LCD panel includes Color Filter (CF) substrate and a Thin Film Transistor (TFT) substrate, and a photomask. A transparency electrode is disposed in opposite side of the above two substrates. Liquid crystal molecules are disposed between the two substrates.

In order to highlight all-in-one sense of realistic image using a Thin Film Transistor Liquid Crystal Display (TFT-LCD), frameless design is emerged. If a frame is removed, the light leakage will be occurred. A black tape is used to overcome the light leakage, however, the black tape may take off after using for a long time.

### SUMMARY

This application provides a display panel and a display apparatus, which can reduce side light leakage or side light reflection of a frameless product.

To achieve the foregoing purpose, this application provides a display panel, including: a substrate, a backlight module disposed opposite to a back side of the substrate; and a polarized layer, covering a lateral side of the substrate, where the polarized layer includes a first polarized layer and a second polarized layer peripherally disposed on the first polarized layer. A light transmittance of the second polarized layer is less than a light transmittance of the first polarized layer. The substrate includes a display region and a lead-wire region peripheral to the display region, the display region corresponding to the first polarized layer covers the lateral side of the substrate, and the lead-wire region corresponding to the second polarized layer covers the lateral side of the substrate. The first polarized layer and the second polarized layer are integrally formed, and the second polarized layer is subjected to carbonization processing by adopting laser or high-intensity light energy.

This application provides a display panel, including: a substrate, a backlight module disposed opposite to a back side of the substrate; and a polarized layer, covering a lateral side of the substrate. The polarized layer includes a first polarized layer and a second polarized layer peripherally disposed on the first polarized layer. A light transmittance of the second polarized layer is less than a light transmittance of the first polarized layer.

Optionally, the first polarized layer and the second polarized layer are formed by using a same covering process.

Optionally, the substrate includes a display region and a lead-wire region peripheral to the display region. The display region corresponding to the first polarized layer covers the lateral side of the substrate; the lead-wire region corresponding to the second polarized layer covers the lateral side of the substrate.

Optionally, the first polarized layer and the second polarized layer are integrally formed, and the second polarized layer is subjected to carbonization processing by laser.

Optionally, a material of the first polarized layer is different from a material of the second polarized layer.

Optionally, the first polarized layer is made of a normal material, and the second polarized layer is made of a low light transmittance material.

Optionally, the first polarized layer is made of a normal material, and the second polarized layer is made of an opaque material.

Optionally, the second polarized layer is subjected to carbonization processing by laser.

Optionally, the substrate includes a display region and a lead-wire region peripheral to the display region, and an entire surface of the first polarized layer covers the display region and the lead-wire region; the second polarized layer covers the lead-wire region and is correspondingly disposed on an inside of the first polarized layer.

Optionally, the substrate includes a display region and a lead-wire region peripheral to the display region, where an entire surface of the first polarized layer covers the display region and the lead-wire region, and the second polarized layer covers the lead-wire region and is correspondingly disposed on a lateral side of the first polarized layer.

Optionally, a thickness of the second polarized layer is less than a thickness of the first polarized layer. A thickness of a part of the first polarized layer corresponding to the lead-wire region is less than a thickness of other parts of the first polarized layer. The first polarized layer is made of a normal material, and the second polarized layer is made of a low light transmittance material or an opaque material.

Optionally, a thickness of the second polarized layer is less than a thickness of the first polarized layer. A thickness of a part of the first polarized layer corresponding to the lead-wire region is equal to a thickness of other parts of the first polarized layer. The first polarized layer is made of a normal material, and the second polarized layer is made of a low light transmittance material or an opaque material.

Optionally, the second polarized layer, or a part of the first polarized layer and the second polarized layer corresponding to the lead-wire region are subjected to carbonization processing by laser.

Optionally, the substrate further includes: an array substrate, a color filter substrate, and a liquid crystal layer disposed between the array substrate and the color filter substrate. A Thin Film Transistor and a first polarizer are successively disposed between the array substrate and the liquid crystal layer. A color filter layer and a second polarizer are successively disposed between the color filter substrate and the liquid crystal layer; and a sealant sealing the array substrate and the color filter substrate.

Optionally, the first polarized layer and the second polarized layer are respectively coated; and the second polarized layer is subjected to carbonization processing by laser.

This application further provides a display apparatus, including the above display panel.

The display panel includes a liquid crystal panel. When the liquid crystal panel is manufactured, polarized board or polarized film is usually disposed on one side of the array substrate facing to a user. The polarized board or polarized film refers to the polarized layer in the embodiment of the current application. Due to an influence of the Thin Film Transistor layer array to the corresponding peripheral metal dense line region, the frameless production will be easily observed as reflecting light to be watched by eyes of the user, which result in the production has a low yield. Since the second polarized layer having lower light transmittance than the first polarized layer is disposed at a peripheral of the polarized layer, the influence of the peripheral metal dense line region is reduced, correspondingly a yield of the frameless production is increased. Furthermore, this application avoids the frame BM design to reduce a cost of the manufacturing materials. Meanwhile, since the second polarized layer can be adapted to the original coating machine, a manufacturing time is correspondingly reduced.

Referring to description and drawings as follow, specific embodiment of this application is disclosed in detail and principle of this application can be used. It should be understood, range of the embodiment of this application is not limited. The embodiment of this application includes more change, amendment and equated embodiment in range of clause and spirit of the claims.

Features described and/or illustrated with respect to one embodiment may be used as the same or similar manner in one or more other embodiments, in combination with features in other embodiments, or replacing features in other embodiments.

It should be noticed, the terms “comprise” and/or “include” used herein specify the existence of stated features, integers, steps, operation, units and/or assemblies, not excluding the existence or addition of one or more other features, integers, steps, operation, units, assemblies and/or combinations of these.

### BRIEF DESCRIPTION OF DRAWINGS

The drawings included are used for providing further understanding of embodiments of this application, constitute part of the description, and are used for illustrating implementation manners of this application, and interpreting principles of this application together with text description. Apparently, the drawings in the following description are merely some embodiments of this application, and for those ordinary skilled in the art, other drawings can also be obtained according to the drawings without contributing creative labor. In the drawings:

FIG. 1 is a manufacturing method schematic diagram of a frame black matrix according to an embodiment of this application.

FIG. 2 is a schematic diagram of a display panel according to the embodiment of this application.

FIG. 3 is a second schematic diagram of a display panel according to the embodiment of this application.

FIG. 4 is a third schematic diagram of a display panel according to the embodiment of this application.

FIG. 5 is a fourth schematic diagram of a display panel according to the embodiment of this application.

FIG. 6 is an overall structure schematic diagram of another display panel according to the embodiment of this application.

FIG. 7 is a schematic diagram of a display apparatus according to the embodiment of this application.

### DETAILED DESCRIPTION

In order to understand technical scheme of this application for the common technical personnel in the field. The following will be clearly and completely described in detail below in combination with the drawings and optional embodiments. Obviously, the following description is only a few embodiments, and is not all embodiments. For the common technical personnel in the field, it is easy to acquire some other drawings without creative work.

Frameless productions: in order to highlight all-in-one sense of a realistic image of a Thin Film Transistor-Liquid Crystal Display (TFT-LCD), a frameless design further is emerged. If a frame is removed, the light leakage will be occurred. A black tape is used to overcome the light leakage, however, the black tape may be stripped after using for a long time.

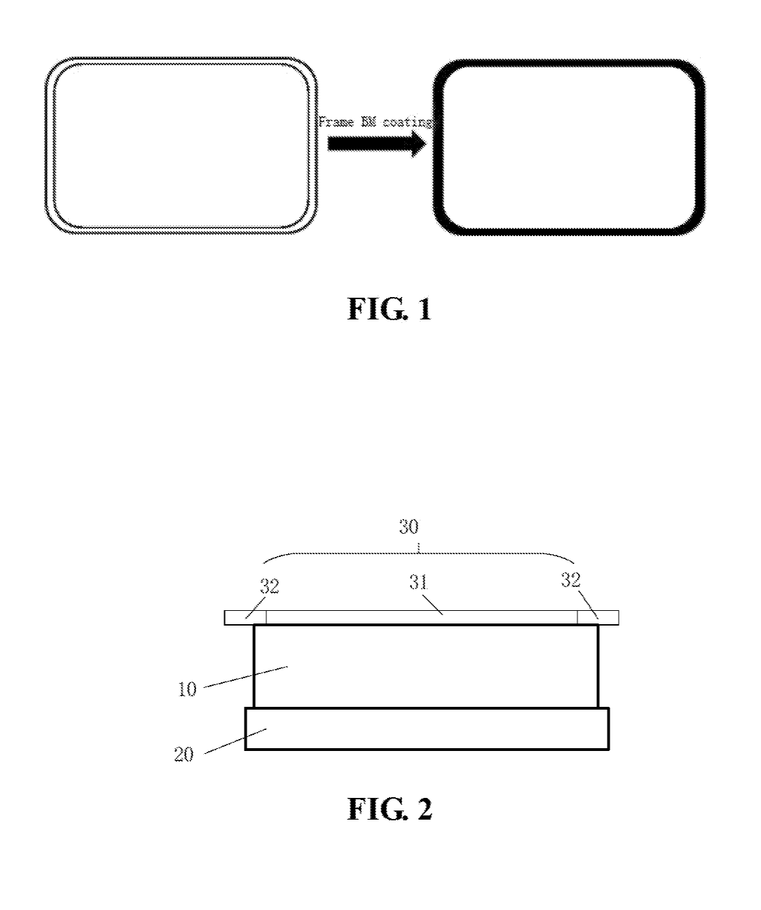

FIG. 1 is a manufacturing method schematic diagram of a frame Black Matrix (BM). As shown in FIG. 1, in order to solve the problem of the stripped black tape, the black tape is replaced by a frame BM, namely that the frame BM is coated on a lead-wire region (peripheral metal dense line region) to absorb the light for blocking the light leaking out. The frame BM has the same blocking function of the black tape. Meanwhile, the problem of the stripped black tape is overcome.

However, the frame BM design should be added materials and processing, particularly the original pasting machine cannot be directly used, such that new manufacturing machine should be added, and a cost is increased. Further, the frame BM design has a high requirement to a shading coefficient, viscosity, waterproofness thereof, which resulting in a promotion of the frame BM is also increased.

FIG. 2 is a schematic diagram of a display panel according to the embodiment of this application. In the Embodiment of FIG. 1, the display panel includes a substrate 10, a backlight module 20 disposed opposite to a back side of the substrate 10, and a polarized layer 30 covering a lateral side of the substrate 10. The polarized layer 30 includes a first polarized layer 31 and a second polarized layer 32 peripherally disposed on the first polarized layer. A light transmittance of the second polarized layer 32 is less than a light transmittance of the first polarized layer.

The display panel includes a liquid crystal panel. When the liquid crystal panel is manufactured, a polarized board or a polarized film is usually disposed on one side of an array substrate facing to a user. The polarized board or the polarized film refers to the polarized layer in the embodiment of the current application. Due to an influence of the Thin Film Transistor (TFT) layer array to the corresponding peripheral metal dense line region, the frameless production will be easily observed as reflecting light to be watched by eyes of the user, which result in the production has a low yield. Since a light transmittance of the second polarized layer is lower than a first polarized layer disposed at a peripheral of the polarized layer, the influence of the peripheral metal dense line region is reduced, correspondingly a yield of the frameless production is increased. This application reduces a cost of the manufacturing materials of the frame BM design. Meanwhile, since the second polarized layer can be adapted to the original coating machine, a manufacturing time is correspondingly reduced.

In one or more embodiments, the substrate includes a display region and a lead-wire region peripheral to the display region. The display region corresponding to the first polarized layer covers the lateral side of the substrate. The lead-wire region corresponding to the second polarized layer covers the lateral side of the substrate. The lead-wire region namely the peripheral metal dense line region, light leakage and light reflection will occur at the peripheral metal dense line region. In this solution, the second polarized layer covers the lead-wire region, which solves the light leakage or light reflection problems.

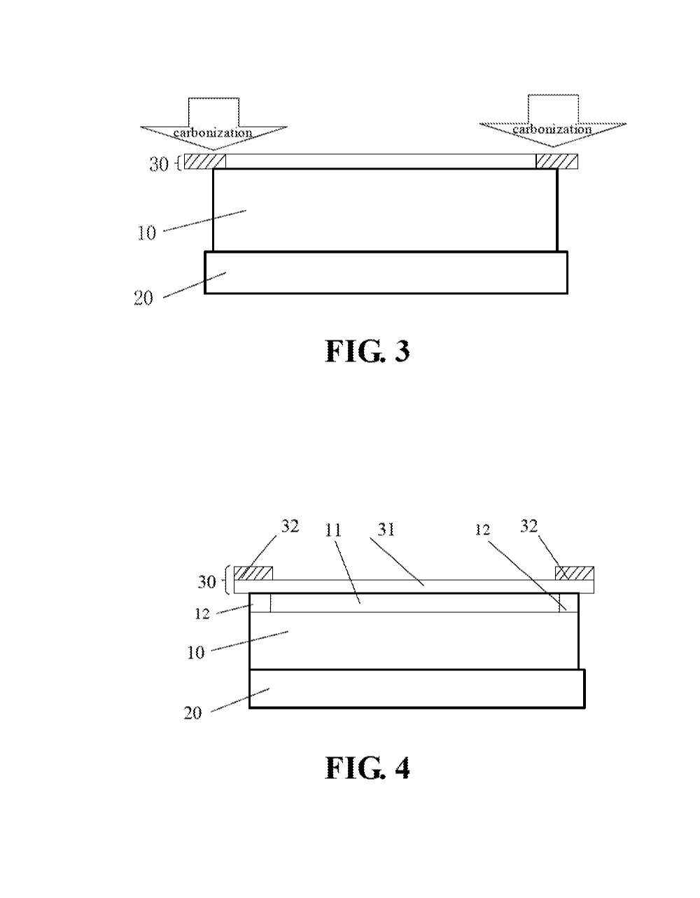

FIG. 3 is a second schematic diagram of a display panel according to the embodiment of this application. In one or more embodiments as shown in FIG. 3, the first polarized layer 31 and the second polarized layer 32 are integrally formed, and the second polarized layer 32 is subjected to carbonization processing by adopting laser or high-intensity light energy. In this solution, the first polarized layer and the second polarized layer are integrally formed, and the peripheral metal dense line region is subjected to carbonization processing by adopting laser or high-intensity light energy. A polarized layer is changed to black by carbonization processing, the polarized layer can be same as the black tape or the frame BM to hide internal components. The polarized layer can overcome the black tape easily coming off, this application reduces a cost of the manufacturing materials of the frame BM design.

In one or more embodiments, a material of the second polarized layer is different from a material of the first polarized layer as shown in FIG. 2. The first polarized layer 31 is made of a normal material, and the second polarized layer 32 is made of a low light transmittance or an opaque material. Parasitic light is removed by the polarized layer, such as 99% dazzle light, and color contrast and maximum visual comfort are improved. In this solution, the second polarized layer made of lower light transmittance material or opaque material avoid the light leakage of the substrate interior and light reflection out of the substrate.

In one or more embodiments, the material of the second polarized layer is different from material of the first polarized layer as shown in FIG. 3. The second polarized layer 32 is subjected to carbonization processing by adopting laser or high-intensity light energy. The first polarized layer and the second polarized layer are respectively coated. The second polarized layer is subjected to carbonization processing by adopting laser or high-intensity light energy independently, A carbonization over bound can be avoid which is integrally formed of the first polarized layer and the second polarized layer.

FIG. 4 is a third schematic diagram of a display panel according to the embodiment of this application. In one or more embodiments as shown in FIG. 4, the substrate of the display panel includes a display region 11 and a lead-wire region 12. The lead-wire region 12 is peripheral to the display region 11. An entire surface of the first polarized layer covers the display region 11 and the lead-wire region 12. The second polarized layer 32 covers the lead-wire region 12, and the second polarized layer 32 is correspondingly disposed on a lateral side or an inside of the first polarized layer 31. In this solution, a gap is avoided between the first polarized layer and the second polarized layer, since the entire surface of the first polarized layer is covered and the second polarized layer is arranged at peripheral to the display region. The first polarized layer and the second polarized layer are stacked together, a hiding effect of the peripheral polarized layer can be increased, and a yield of the display apparatus is correspondingly increased.

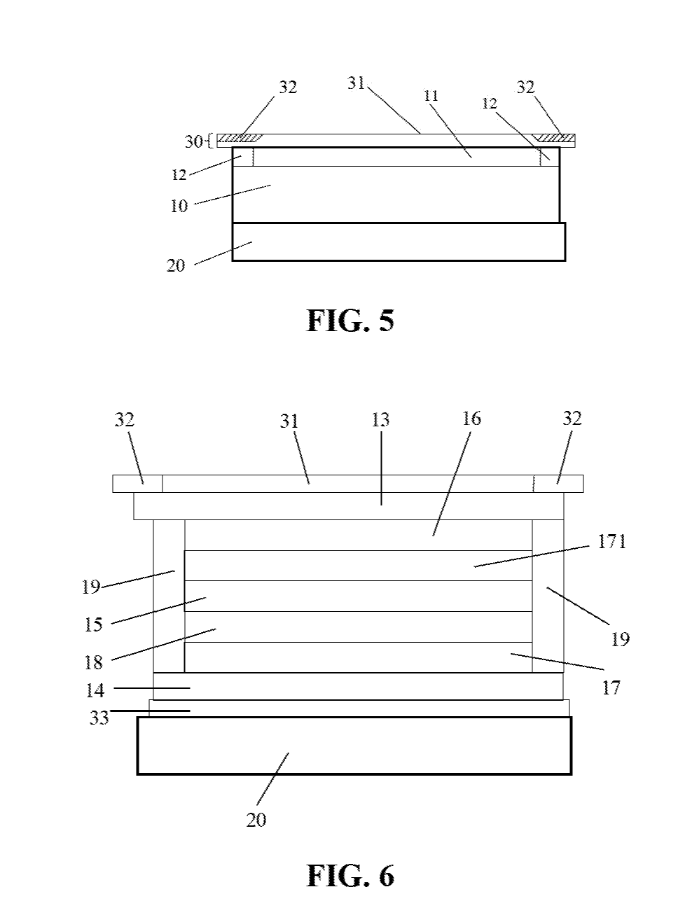

FIG. 5 is a fourth schematic diagram of a display panel according to the embodiment of this application. In one or more embodiments, a thickness of the second polarized layer 32 of the display panel is less than a thickness of the first polarized layer 31. A thickness of a part of the first polarized layer 31 corresponding to the lead-wire region 12 is less than a thickness of other parts of the first polarized layer, and the first polarized layer 31 is made of normal material. The second polarized layer 32 is made of a low light transmittance material or an opaque material. In this solution, a thickness of a part of the first polarized layer corresponding to the lead-wire region is thinner than a thickness of the other part of the first polarized layer. The second polarized layer has a same thickness as the part of first second polarized layer corresponding to the lead-wire region, such that a whole thickness of the two polarized layers will be thinner. In a suitable situation, a thickness of a part of the polarized layer corresponding to the lead-wire region is same as the other parts.

In one or more embodiments, as shown in FIG. 3 and FIG. 5, the second polarized layer 32 is subjected to carbonization processing by adopting laser or high-intensity light energy, or a part of the first polarized layer 31 and the second polarized layer 32 corresponding to the lead-wire region 12 are subjected to carbonization processing by adopting laser or high-intensity light energy. In this solution, carbonization processing is performed on the second polarized layer or the second polarized layer and the part of the first polarized layer corresponding to the lead-wire region by adopting laser or high-intensity light energy, thereby obtaining a polarized layer that is carbonized into black. This ensures a covering effect as well as improving a blocking effect of the lead-wire region. In addition, black color can absorb light. Backlight inside the substrate can be blocked and absorbed, in addition reflected light brought by external light can also be better solved.

FIG. 6 is an overall structure schematic diagram of another display panel according to the embodiment of this application. Optionally, the display panel further includes an array substrate 13, a color filter substrate 14 and a liquid crystal layer 15. The liquid crystal layer 15 disposed between the array substrate 13 and the color filter substrate 14. The substrate 10 further includes a Thin Film Transistor 16, a first polarizer 171, a color filter layer 17 and a second polarizer 18. The Thin Film Transistor 16 and the first polarizer 171 are successively disposed between the array substrate 13 and the liquid crystal layer 15. The color filter layer 17 and the second polarizer 18 are successively disposed between the color filter substrate 14 and the liquid crystal layer 15. The substrate 10 further includes a sealant 19 sealing the array substrate 13 and the color filter substrate 14. The sealant prevents dust from entering the liquid crystal layer disposed between the array substrate and the color filter substrate. The polarizers are disposed because a polarizer allows only light with a specific vibration direction to pass through. A major function of the polarizers is to filter a light source without a specific polarization direction emitted by the backlight module and convert the light source into polarized light. The polarized light is then twisted by liquid crystal molecules, thereby controlling an amount of light passed through and achieving the purpose of controlling luminance of the Liquid Crystal Display. Further, a rear polarized layer 33 is disposed between the backlight module and the color filter substrate. The rear polarized layer 33 and the polarized layer 30 are disposed at two opposite sides of the substrate.

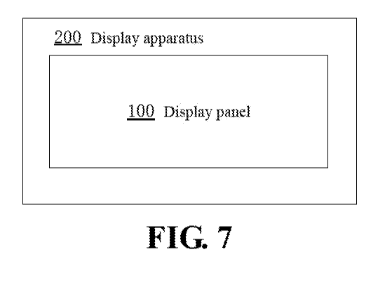

FIG. 7 is a schematic diagram of a display apparatus according to the embodiment of this application. A display apparatus 200 includes the above display panel 100.

The display panel includes a liquid crystal panel. When the liquid crystal panel is manufactured, polarized board or polarized film is usually disposed on one side of the array substrate facing to a user. The polarized board or polarized film refers to the polarized layer in the embodiment of the current application. Due to an influence of the Thin Film Transistor layer array to the corresponding peripheral metal dense line region, the frameless production will be easily observed as reflecting light to be watched by eyes of the user, which result in the production has a low yield. Since the second polarized layer having lower light transmittance than the first polarized layer is disposed at a peripheral of the polarized layer, the influence of the peripheral metal dense line region is reduced, correspondingly a yield of the frameless production is increased. Furthermore, this application avoids the frame BM design to reduce a cost of the manufacturing materials. Meanwhile, since the second polarized layer can be adapted to the original coating machine, a manufacturing time is correspondingly reduced.

As the above, it should be understood that this application has been described with reference to certain optional and alternative embodiments which are intended to be exemplary only and do not limit the full scope of this application as set forth in the appended claims.

What is claimed is:

1. A display panel, comprising:
a substrate;
a backlight module disposed opposite to a back side of the substrate; and
a polarized layer, covering a lateral side of the substrate; wherein the polarized layer comprises a first polarized layer and a second polarized layer peripherally disposed on the first polarized layer; and a light transmittance of the second polarized layer is less than a light transmittance of the first polarized layer;
wherein the substrate comprises a display region and a lead-wire region peripheral to the display region; the display region corresponding to the first polarized layer covers the lateral side of the substrate; the lead-wire region corresponding to the second polarized layer covers the lateral side of the substrate;
wherein the first polarized layer and the second polarized layer are integrally formed;
the second polarized layer is subjected to carbonization processing by laser.

2. A display panel, comprising:
a substrate;
a backlight module disposed opposite to a back side of the substrate; and
a polarized layer, covering a lateral side of the substrate; wherein the polarized layer comprises a first polarized layer and a second polarized layer peripherally disposed on the first polarized layer; and a light transmittance of the second polarized layer is less than a light transmittance of the first polarized layer.

3. The display panel according to claim 2, wherein the substrate comprises a display region and a lead-wire region peripheral to the display region; the display region corresponding to the first polarized layer covers the lateral side of the substrate; the lead-wire region corresponding to the second polarized layer covers the lateral side of the substrate.

4. The display panel according to claim 2, wherein the first polarized layer and the second polarized layer are integrally formed; the second polarized layer is subjected to carbonization processing by laser.

5. The display panel according to claim 2, wherein the first polarized layer is made of a normal material, and the second polarized layer is made of a low light transmittance material.

6. The display panel according to claim 5, wherein the second polarized layer is subjected to carbonization processing by laser.

7. The display panel according to claim 2, wherein the substrate comprises a display region and a lead-wire region peripheral to the display region;
an entire surface of the first polarized layer covers the display region and the lead-wire region; the second polarized layer covers the lead-wire region and is correspondingly disposed on an inside of the first polarized layer.

8. The display panel according to claim 7, wherein a thickness of the second polarized layer is less than a thickness of the first polarized layer;
a thickness of a part of the first polarized layer corresponding to the lead-wire region is less than a thickness of other parts of the first polarized layer; and
the first polarized layer is made of a normal material and the second polarized layer is made of a low light transmittance material or an opaque material.

9. The display panel according to claim 7, wherein the second polarized layer, or a part of the first polarized layer and the second polarized layer corresponding to the lead-wire region are subjected to carbonization processing by laser.

10. The display panel according to claim 2, wherein the substrate further comprises:
an array substrate, a color filter substrate, and a liquid crystal layer disposed between the array substrate and the color filter substrate; and
a Thin Film Transistor and a first polarizer are successively disposed between the array substrate and the liquid crystal layer;
wherein the color filter layer and the second polarizer are successively disposed between the color filter substrate and the liquid crystal layer; and
a sealant sealing the array substrate and the color filter substrate.

11. A display apparatus, comprising a display panel;
wherein the display panel comprises:
a substrate;
a backlight module disposed opposite to a back side of the substrate; and
a polarized layer covering a lateral side of the substrate; wherein the polarized layer comprises a first polarized layer and a second polarized layer peripherally disposed on the first polarized layer; and a light transmittance of the second polarized layer is less than a light transmittance of the first polarized layer.

12-19. (canceled)

20. The display panel according to claim 2, wherein the first polarized layer and the second polarized layer are formed by using a same covering process.

21. The display panel according to claim 2, wherein a material of the first polarized layer is different from a material of the second polarized layer.

22. The display panel according to claim 2, wherein the first polarized layer is made of a normal material, and the second polarized layer is made of an opaque material.

23. The display panel according to claim 2, wherein the substrate comprises a display region and a lead-wire region peripheral to the display region, wherein
an entire surface of the first polarized layer covers the display region and the lead-wire region, and the second polarized layer covers the lead-wire region and is correspondingly disposed on a lateral side of the first polarized layer.

24. The display panel according to claim 7, wherein
a thickness of the second polarized layer is less than a thickness of the first polarized layer;
a thickness of a part of the first polarized layer corresponding to the lead-wire region is equal to a thickness of other parts of the first polarized layer; and
the first polarized layer is made of a normal material, and the second polarized layer is made of a low light transmittance material or an opaque material.

25. The display panel according to claim 2, wherein the first polarized layer and the second polarized layer are respectively coated; and the second polarized layer is subjected to carbonization processing by laser.
